(19) United States
(12) Patent Application Publication
(10) Pub. No.: US 2006/0124007 A1
(43) Pub. Date: Jun. 15, 2006

(54) Roll of a printing press having a filling of a foamed material

(76) Inventor: Eduard Hoffmann, Bobingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/283,030

(22) Filed: Nov. 18, 2005

(30) Foreign Application Priority Data
Nov. 19, 2004 (DE) 10 2004 055 833.7

(51) Int. Cl. B41F 27/06

(52) U.S. Cl. 101/376

(57) ABSTRACT

A roll having a filling of a foamed material, in particular for a printing press, having an outer, tubular shell forming a surface of the roll and a core of a foamed material, in particular of metal foam, enclosed by the tubular shell. The core of the foamed material is tubular.

This application claims the priority of German Patent Document No. 10 2004 055 833.7, filed Nov. 19, 2004, the disclosure of which is expressly incorporated by reference herein.

### BACKGROUND AND SUMMARY OF THE INVENTION

The invention relates to a roll having a filling of a foamed material, in particular for a printing press.

For productivity reasons, printing presses are being designed with greater and greater web widths, for which reason longer cylinders and rolls are becoming necessary on the printing presses. As a result, ultimately the weight of the cylinders and rolls of the printing press is also increased. However, a high weight of rolls can be disadvantageous. For example, heavy rolls can be handled only with a great deal of effort. Furthermore, rolls with a high weight tend to sag, which has a detrimental influence on the printing quality.

In German Patent Document No. DE 297 24 693 U1, a cylinder for a printing press is proposed which, in order to minimize weight, has an outer, tubular shell and a core of metal foam. The core of metal foam fills the interior of the cylinder, bounded by the tubular shell, virtually completely. Only at the axial ends of the cylinder are recesses for accommodating bearing bushes introduced into the core of metal foam. With the constructional principle for cylinders described according to DE 297 24 639 U1, the weight of the same can be reduced to a certain extent.

On this basis, the present invention is based on the problem of providing a novel type of roll, in particular for a printing press. According to the invention, the core of the foamed material is tubular.

In the spirit of the present invention, it is provided to form the core of the foamed material to be tubular, just like the outer shell. In this way, the weight of the roll can be reduced once more as compared with the solution according to DE 297 24 693 U1.

According to an advantageous development of the present invention, the tubular core of foamed material is positioned between the outer tubular shell and an inner tubular shell, the inner tubular shell being positioned concentrically with respect to the outer tubular shell, and the tubular core of the foamed material firstly adjoining the inner tubular shell directly and secondly adjoining the outer tubular shell directly.

According to an alternative advantageous development of the present invention, the tubular core of the foamed material is positioned between the outer tubular shell and a shaft or spindle, the shaft or spindle being positioned concentrically with respect to the outer tubular shell. The tubular shell of the foamed material adjoins the outer tubular shell directly.

On its radially outer surface, with which the same adjoins the outer tubular shell, the tubular core preferably has at least one groove, the, or each, groove being formed as a flow duct for fluid for the temperature control of the roll.

### BRIEF DESCRIPTION OF THE DRAWINGS

Preferred developments of the invention emerge from the following description. Exemplary embodiments of the invention will be explained in more detail by using the drawings, without being restricted thereto.

FIG. 1 shows a schematic cross-section through a roll according to the invention according to a first exemplary embodiment of the invention.

FIG. 2 shows a schematic cross-section through a roll according to the invention according to a second exemplary embodiment of the invention.

FIG. 3 shows a schematic cross-section through a roll according to the invention according to a third exemplary embodiment of the invention.

FIG. 4 shows a schematic cross-section through a roll according to the invention according to a fourth exemplary embodiment of the invention.

### DETAILED DESCRIPTION OF THE DRAWINGS

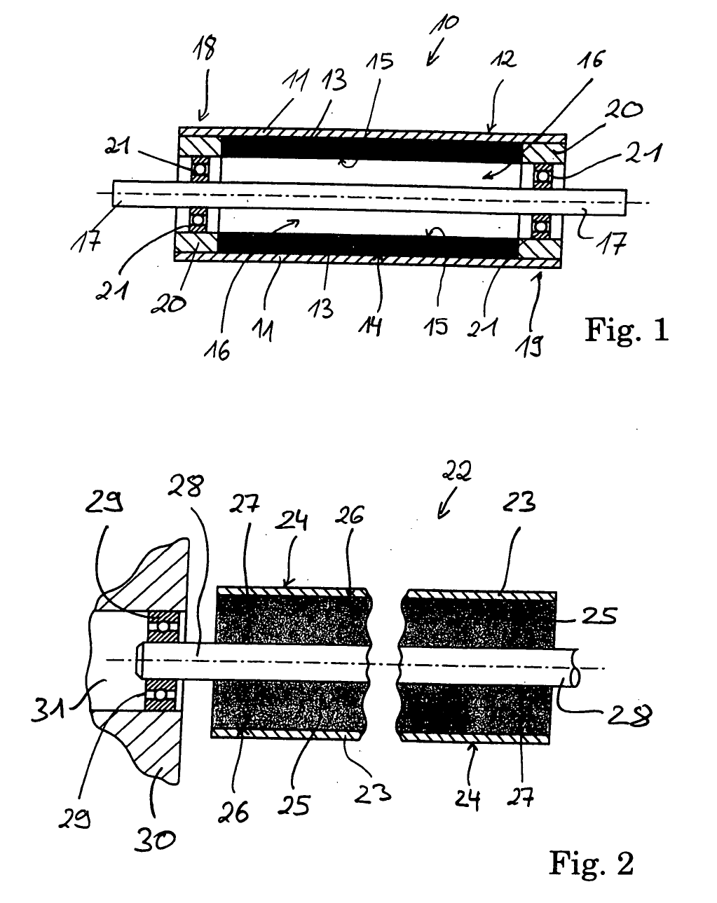

In the following text, the present invention will be described in greater detail with reference to FIGS. 1 to 4.

FIG. 1 shows a roll 10 according to the invention, for example a guide roll according to a first exemplary embodiment of the present invention, the roll 10 having an outer tubular shell 11, which forms an outer surface 12 of the roll. The outer shell 11 encloses a core 13 of a foamed material, specifically of metal foam. In the spirit of the present invention, the core 13, just like the outer shell 11, is tubular. The core 13 of the foamed material accordingly does not fill the space or cavity bounded by the outer shell 11 completely but only partly.

As can be gathered from FIG. 1, the tubular core 13 directly adjoins the outer shell 11 with a radially outer surface 14. A radially inner surface 15 of the tubular core 13 of the foamed material in this case bounds a cavity 16, through which a spindle or shaft 17 extends in the exemplary embodiment of FIG. 1. As can be gathered from FIG. 1, a free space is formed between the tubular core 13 and the spindle 17; accordingly the spindle 17 does not fill the cavity 16 bounded by the radially inner surface 15 of the tubular core 13 completely but only partly.

In the exemplary embodiment of FIG. 1, the tubular core 13 does not extend over the entire axial length of the outer tubular shell 11; instead the tubular core 13 ends at a distance from the two lateral ends 18 and 19 of the tubular shell 11. In these regions left free by the tubular core 13, bearing bases 20 interacting with corresponding spherical bearings 21 are integrated into the outer tubular shell 11 at the lateral ends 18 and 19, in order in this way to mount the roll 10 on a frame of the printing press.

FIG. 2 shows a second exemplary embodiment of a roll 22 according to the invention. The roll 22 of FIG. 2 again has an outer tubular shell 23, which forms an outer surface 24 of the roll 22. The outer tubular shell 23 again encloses a core 25 of a foamed material, the core 25 of the foamed material being tubular. A radially outer surface 26 of the core 25 adjoins the tubular shell 23 directly. A cavity defined by a radially inner surface 27 of the tubular core 25 is filled completely by a spindle or shaft 28 in the exemplary embodiment of FIG. 2. The tubular core 25 accordingly firstly adjoins the outer tubular shell 23 directly and secondly adjoins the shaft 28 directly.

In the exemplary embodiment of FIG. 2, spherical bearings 29 for mounting the roll 22 on a machine frame 30 are not integrated into the roll as in the exemplary embodiment of FIG. 1 but instead into the machine frame 30. Thus, FIG. 2 shows that the spherical bearings 29 are integrated into a cavity 31 in the machine frame 30 for this purpose.

The common factor in the exemplary embodiments of FIGS. 1 and 2 is that the rolls 10 and 22 shown there each have an outer tubular shell 11 and 23, a tubular core 13 and 25 of a foamed material being formed within the tubular shell 11 and 23, a spindle or shaft 17 and 28 extending through the core 13 and 25 of the respective roll 10 and 22. The spindle or shaft 17 and 28, the tubular core 13 and 25 and the outer tubular shell 11 and 23 are in each case arranged concentrically with respect to one another.

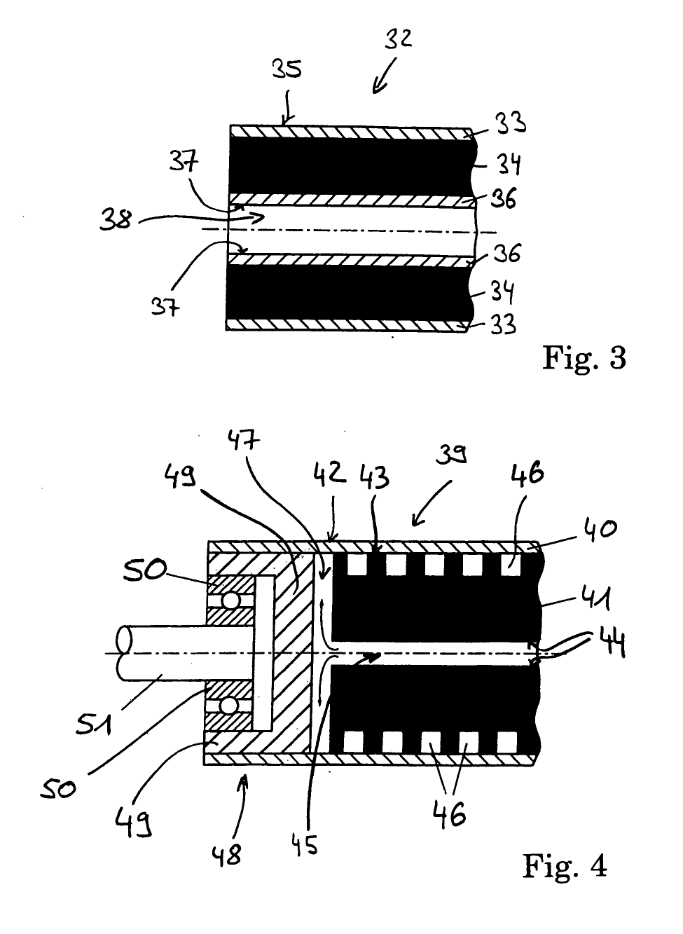

FIG. 3 shows a detail from a further roll 32 according to the invention, the roll 32 of FIG. 3 again having an outer tubular shell 33 and a core 34 of metal foam. The outer tubular shell 33 forms an outer surface 35 of the roll 32; the core 34 is again tubular. In the exemplary embodiment of FIG. 3, the roll 32 has an inner tubular shell 36 in addition to the outer tubular shell 33. The core 34 of metal foam is positioned between the two tubular shells 33 and 36, the core 34 firstly adjoining the outer shell 33 directly and secondly adjoining the tubular shell 36 directly. The two tubular shells 33 and 36 and the tubular core 34 are again concentric with one another. An inner surface 37 of the inner tubular shell 36 bounds a cavity 38 through which, for example, a spindle or shaft, not illustrated, belonging to the roll 32 can be guided.

It should be pointed out that the outer tubular shell 33 and the inner tubular shell 36 can be produced from different materials or from the same material. The two tubular shells 33 and 36, just like the tubular core 34, can be produced from a foamed material, preferably from a metal foam. The outer shell 33 and the inner shell 36 can be welded or drawn.

A further exemplary embodiment of a roll 39 according to the invention is shown by FIG. 4. The roll 39 also has an outer tubular shell 40 and a core 41 of a foamed material enclosed by the tubular shell 40, the shell 40 again forming an outer surface 42 of the roll 39 and the core 41 again being tubular. In the exemplary embodiment of FIG. 4, the tubular core 41 adjoins the outer shell 40 with a radially outer surface 43. A radially inner surface 44 of the tubular core 41 of the foamed material bounds a cavity 45.

In the exemplary embodiment of FIG. 4, a spiral groove 46 is introduced into the radially outer surface 43 of the tubular core 41. The spiral groove 46, just like the cavity 45, is used to form a flow duct for a fluid which is used for the temperature control, in particular for the cooling, of the roll 39 during operation. This makes it possible to minimize thermally induced deformations of the roll 39 during printing operation and thus to ensure improved printing quality over the entire printing operation. The fluid can be discharged from the roll 39 via a cavity 47 adjoining the core 41 laterally. It should be pointed out that there can also be a plurality of grooves and that the, or each, groove 46 can of course also be used in the exemplary embodiments according to FIGS. 1 to 3.

As can be gathered from FIG. 4, in this exemplary embodiment bearing bases 49 with spherical bearings 50 are again integrated into the roll 39 at lateral ends 48. At each axial end of the roll 39, the spherical bearings 50 engage in a bearing journal 51, via which the roll 39 is mounted on a machine frame of the printing press.

The rolls 10, 22, 32 and 39 shown in FIGS. 1 to 4 can be constructed, for example, as guide rolls, their outer surfaces 12, 24, 35 and 42 then being coated with an ink-repelling layer of, for example, chromium, Teflon® or glass beads. It is also conceivable that the rolls 10, 22, 32 and 39 shown in FIGS. 1 to 4 are constructed as inking rolls or ductor rolls, the outer surfaces 12, 24, 35 and 42 then being coated with an ink-accepting layer of, for example, copper, polyamide or ceramic.

By using the above-described rolls according to the invention, a repeated weight reduction can be implemented. By means of the integration of, for example, spiral grooves into the tubular core of the foamed material, efficient cooling of the roll during the operation of the same can be implemented. In this way, thermally induced deformations of the roll can be minimized.

List of reference symbols:
10 Roll
11 Shell
12 Surface
13 Core
14 Surface
15 Surface
16 Cavity
17 Shaft
18 End
19 End
20 Bearing base
21 Spherical bearing
22 Roll
23 Shell
24 Surface
25 Core
26 Surface
27 Surface
28 Shaft
29 Spherical bearing
30 Machine frame
31 Cavity
32 Roll
33 Shell
34 Core
35 Surface
36 Shell
37 Surface
38 Cavity
39 Roll
40 Shell
41 Core
42 Surface
43 Surface
44 Surface
45 Cavity
46 Groove
47 Cavity
48 End
49 Bearing base
50 Spherical bearing
51 Bearing journal

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A roll, in particular for a printing press, having an outer, tubular shell forming a surface of the roll and a core of a foamed material, in particular of metal foam, enclosed by the tubular shell, wherein the core of the foamed material is tubular.

2. The roll having a core of a foamed material according to claim 1, wherein the tubular core of the foamed material is positioned between the outer tubular shell and an inner tubular shell.

3. The roll according to claim 2, wherein the inner tubular shell is positioned concentrically with respect to the outer tubular shell.

4. The roll according to claim 2, wherein the tubular core of the foamed material firstly adjoins the inner tubular shell directly and secondly adjoins the outer tubular shell directly.

5. The roll according to claim 2, wherein the outer tubular shell and the inner tubular shell are formed of a different material.

6. The roll according to claim 2, wherein the outer tubular shell and the inner tubular shell are formed of a same material.

7. The roll according to claim 2, wherein the outer tubular shell and the inner tubular shell are formed of the foamed material, in particular of metal foam.

8. The roll according to claim 1, wherein the tubular core of the foamed material is positioned between the outer tubular shell and a spindle or a shaft.

9. The roll according to claim 8, wherein the shaft is positioned concentrically with respect to the outer tubular shell.

10. The roll according to claim 8, wherein the tubular core of the foamed material firstly adjoins the shaft directly and secondly adjoins the outer tubular shell directly.

11. The roll according to claim 8, wherein the tubular core adjoins the outer tubular shell directly and wherein a cavity or free space is defined between the shaft and the tubular core.

12. The roll according to claim 1, wherein the tubular core defines a groove on a radially outer surface of the tubular core.

13. The roll according to claim 12, wherein the groove is formed as a flow duct and wherein a fluid flows through the groove for temperature control of the roll.

14. The roll according to claim 12, wherein the groove is spiral.

15. The roll according to claim 1, wherein the roll is a guide roll and wherein the surface of the roll is coated with an ink-repelling layer.

16. The roll according to claim 1, wherein the roll is an inking roll or a ductor roll and wherein the surface of the roll is coated with an ink-accepting layer.

17. A roll of a printing press, comprising:
a tubular shell forming an outer surface of the roll; and
a core formed of a foam material disposed within the tubular shell and defining a cavity extending through an entire axial length of the core.

18. The roll according to claim 17, wherein the foam material is a metal foam.

19. The roll according to claim 17, wherein a shaft extends through the entire axial length of the core and within the cavity.

20. The roll according to claim 17, wherein the core defines a groove on a radially outer edge of the core.

21. A method of forming a roll of a printing press, comprising the steps of:
disposing a core formed of a foam material within a tubular shell, wherein the core defines a cavity extending through an entire axial length of the core.

22. A method of controlling a temperature of a printing press, comprising the steps of:
flowing a fluid through a groove defined by a core wherein the core is disposed within a tubular shell and wherein the groove is included on a radially outer edge of the core.

23. The method according to claim 22, wherein the core is formed of a foam material and wherein the core defines a cavity extending through an entire axial length of the core.
